(19) United States
(12) Patent Application Publication
(10) Pub. No.: US 2011/0001371 A1
(43) Pub. Date: Jan. 6, 2011

(54) SYSTEM FOR THE CIRCULATION OF FILTERED AIR INSIDE THE WIND TURBINE

(75) Inventors: Beñat Landeta Manzano, Zamudio (ES); Oscar Alvarez Alonso, Zamudio (ES)

Correspondence Address: LADAS & PARRY LLP, 26 WEST 61ST STREET, NEW YORK, NY, 10023, US

(73) Assignee: GAMESA INNOVATION & TECHNOLOGY, S.L.

(21) Appl. No.: 12/830,493

(22) Filed: Jul. 6, 2010

(30) Foreign Application Priority Data
Jul. 6, 2009 (ES) 200901539

(51) Int. Cl. H02K 9/04

(52) U.S. Cl. 310/58

(57) ABSTRACT

System for the circulation of filtered air inside the wind turbine (1) of a quality which is free from particles of sand and dust, for the ventilation of components in the turbine's interior.

The system (6) is hardly invasive, is installed at the door (3) which leads inside the tower (2) of a wind turbine (1), or, alternatively, this door (3) may be substituted by a door equipped with the system (6).

The system (6) allows for regulating the air flow input, as well as for varying the efficiency of the filtration depending on the conditions demanded by the place where the wind turbine is located (1).

### FIELD OF THE INVENTION

This invention relates with the ventilation of critical equipment and components of a wind turbine, and more specifically, a system for the circulation of quality air, free of contaminating particles, to the interior of the wind turbine, avoiding contamination due to infiltration of dust and sand.

### BACKGROUND OF THE INVENTION

Because wind turbines operate in highly variable surroundings, this implies that the operational parameters of the different elements which compose it are affected by environmental conditions. The increase in operating speed of different elements and equipment, the management of increasingly higher voltages and elevated environmental temperatures may cause overheating of the gearbox, generator, transformer, electrical components of the power system, guide system, etc.

When the wind turbine is located in hot areas, such as, for example, desert settings, the wind turbine's internal temperature increases generally due to the effects of solar radiation and the ambient temperature, therefore the heat generated by determined components and systems may need to be dissipated.

At the moment, heat is mainly dissipated through natural convection, taking advantage of the natural pull of the chimney effect of the wind turbine's tower chimney, or otherwise, through forced convection, with small fans installed above the most critical components (as is the case with cabinets housing power electronics). In either case, air from outside the wind turbine is used, however this air is contaminated with dust and sand particles which have a considerable effect on the normal functioning of the turbine's component's, therefore requiring filtration of the air taken from outside for the subsequent ventilation of these components of the turbine.

This problem provokes the need for implementing a system for circulating air free of dust and sand contamination in previously installed wind turbines, a hardly invasive system capable of being installed on any type of wind turbine, while simultaneously permitting the regulation of the air flow depending on the need for ventilation, and having the pertinent quality.

In the State of the Art solutions are available for circulating clean air inside wind turbines, as is the case with patent U.S. Pat. No. 6,439,832 and PCT WO2008098573 described, in general terms, below.

U.S. Pat. No. 6,439,832 belonging to AERODYN describes a device for preventing the entry of humid air with considerable salt content to offshore wind turbines. The device takes in air from outdoors, which is then filtered through centrifugal effect, thereby left free of saline content.

Patent WO2008098573 belonging to VESTAS describes a recirculation system which takes in air from outdoors for ventilating enclosed spaces (nacelle, electrical power cabinets . . . ) with the possibility of accommodating an exchanger for either heating or cooling the components inside the wind turbine. It has an opening with an integrated filter for intaking air from outdoors as to avoid the entry of contaminated air inside the closed structure while, at the same time, provide air for ventilation which is particle-free.

However, the solution proposed by VESTAS does not address the inconvenience related with the implementation of a system for the circulation of filtered air inside already installed wind turbines due to the fact that because these systems are invasive, they require modifications to the placement and structure of components, most likely resulting in elevated costs as well as complications inherent to carrying these out. Furthermore, each equipment and/or component with overheating problems requires its own air recirculation system, therefore implying the installation of as many systems as there are critical equipment and/or components in the wind turbine, and the design of each in accordance with particular construction characteristics and operational specifications.

Lastly, the state of the art solutions do not permit a variable air flow according to the ventilation required at any given moment, which would result in a considerable increase of the system's energy efficiency.

### DESCRIPTION OF THE INVENTION.

According to this invention, a system is proposed for air circulation of sufficient quality for the dissipation of heat generated by already installed critical components of the wind turbine, which avoids contamination due to infiltrated air containing dust and sand particles, being a hardly invasive system while permitting the regulation of the air flow depending on the need for dissipation.

This invention proposes an air circulation system, installed at the access to the interior of the wind turbine's tower, which given the characteristics related with its construction and functions, allows for a non-invasive installation at any type of wind turbine, guaranteeing the circulation of quality, filtered air adequate for the requirements of all critical equipment and/or components.

One of the objectives of this invention is to provide a treated air circulation system which is equipped with a decantation phase for particles of larger granulometry, a filter phase for particles of smaller size, a stabilization of air flow and ventilation phase in order to force the air flow through the different phases and drive it toward the inside of the wind turbine.

Another objective of this invention is to provide a system which circulates treated air and which is equipped with a system for regulating the air flow introduced into the wind turbine depending on the flow required for the dissipation of heat generated by critical equipment and/or components as well as the flow necessary for overpressure inside the wind turbine.

Yet another objective of the invention is to provide the system for regulating the air flow with a speed variator which acts upon the rotational speed of the fans through the regulation control loop.

Still another objective of this invention is to provide the speed variator's regulation control loop with a probe which detects the upper temperature limit of the lowest operational mode of critical equipment and/or components as well as a measuring device which detects the air flow extracted for ventilation on behalf of the wind turbine's different equipment, above which the flow of the system fans must be maintained in order to maintain overpressure inside the wind turbine.

Yet another objective of the invention is to provide the regulatory system with a solution which allows for maintaining the required air flow as sedimentation accumulates on the filters during the filtration phase. To this end, a differential pressure probe is included which acts on the upon the fan speed variator's control loop.

Yet another objective of the invention is to provide the invention with a system which allows for detecting the sedimentation accumulated on the filters during the filtration phase by using a pressure probe or pressostat for detecting a drop in pressure which requires the replacement of said filters.

Another objective of the invention is to provide a treated air circulation system whose filtration phase allows for easily replacing filters depending on the efficiency required, thus enabling the system's adaptation to different characteristics of its environmental surroundings.

Yet another objective of this invention is to provide gates with mobile slats for sealing closed the air inputs, designed to this effect in the already installed wind turbine to prevent the entry of air from outdoors when the system is functioning, favoring the overpressure effect inside the wind turbine.

The last objective of this invention is to provide the system for the circulation of filtered air with a control system for opening and closing which guarantees a maximum angular speed for opening or closing the wind turbine's access door, with a lock system for any of its open positions, allowing operators to safely access the interior of the wind turbine without the risk of the door knocking them due to strong gusts of wind and which, for safety reasons, automatically disconnects when personnel access the interior of the wind turbine.

### BRIEF DESCRIPTION OF THE DRAWINGS

FIG. 1 shows a general view of an elevated conventional wind turbine.

FIG. 2 provides an exploded view of the air circulation system field of the invention.

FIG. 3 provides an exploded view of the air circulation system field of the invention.

FIG. 4 provides the view of a cross-section of the air circulation system field of the invention.

### DESCRIPTION OF THE PREFERENTIAL EMBODIMENT.

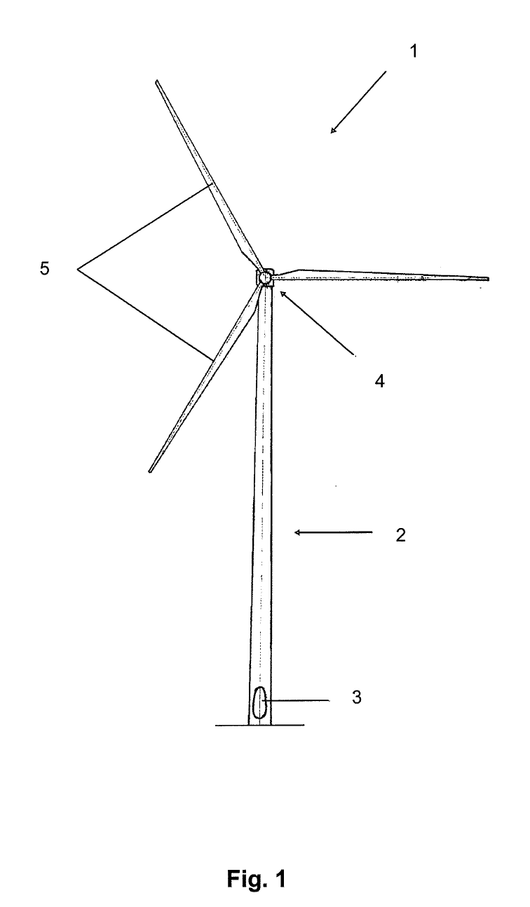

FIG. 1 shows a conventional wind turbine (1) comprised of a tower (2) equipped with an access door (3) and a nacelle (4) equipped with blades (5) located at the top end of the tower (2).

This air circulation system (6) field of the invention is installed at the access to the interior of the tower (2) of a wind turbine (1), in other words, it is assembled in place of the access door (3) of the tower (2), carrying out the functions of both the access door and those of an air circulation system.

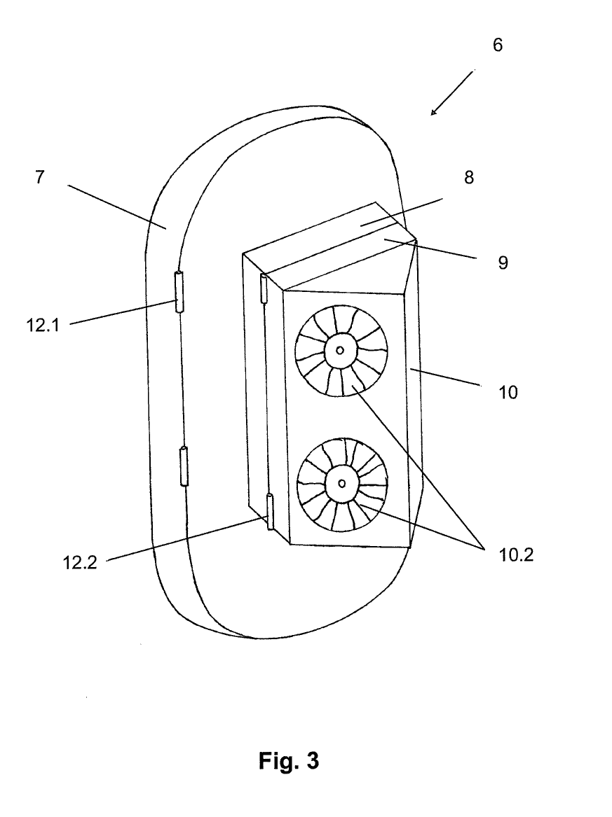

To this end, the air circulation system (6) has the same shape as the access door (3) which leads to the tower (2) of a wind turbine (1). See FIG. 3 which shows the system (6) field of the invention as seen from inside the tower (2).

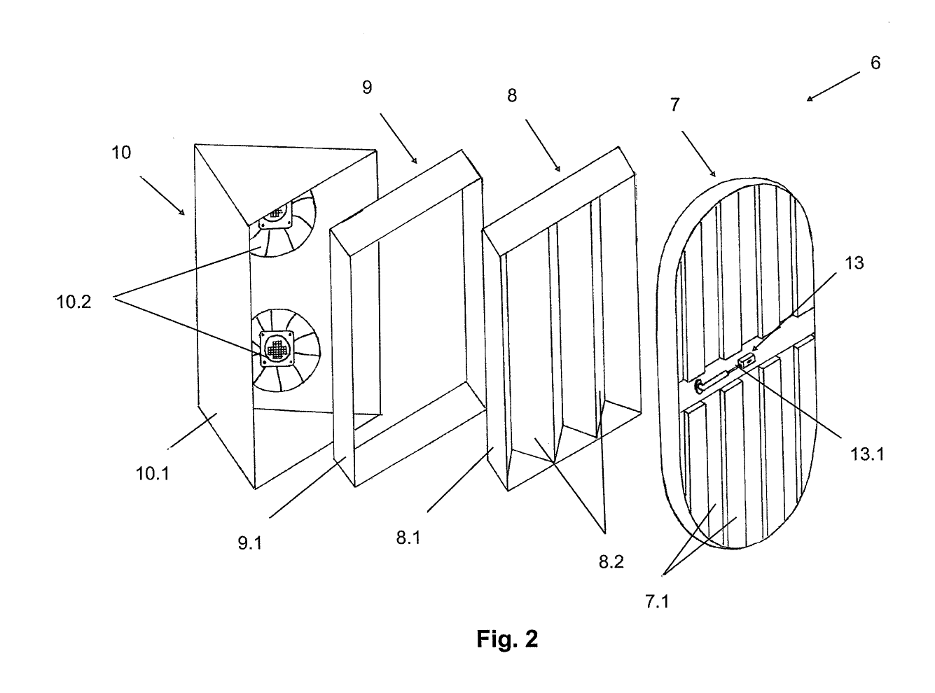

As is shown in FIG. 2, this treated air circulation system (6) has a decantation phase (7), a filtration phase (8), an air stabilization phase (9) and a phase for driving the treated air (10).

The decantation phase (7) filters the larger particles of dust and sand contained in the air brought in from outside the wind turbine (1). To this end, it is composed of a series of metallic slats (7.1) set up in a staggered formation. The unit as a whole determines the shape of a door (3) and has a series of holes (not shown) on its lower part through which the sand from the decanted air falls when knocked against the slats (7.1).

The filtration phase (8) carries out the filtration of the finer particles contained in the air after having passed through the decantation phase (7), and is composed of a sealed rectangular housing (8.1) which accommodates some filters (8.2) which are set up in a V-shape for an improved performance of the filtration section. These filters (8.2) will preferably be made of a synthetic, cellulose or fiberglass material, possible impregnated with resin for a greater efficiency of the filtration, depending on the needs of the place where the wind turbine is installed (1).

The air stabilization phase (9) consists of an air chamber, known as a plenum, the shape of which (9.1) depends on the shape of the housing (8.1) of the filtration phase (8) and is located immediately following this filtration phase, making the incoming air flow coming from the decantation phase (7) pass through the entire filtration surface (8.2).

Lastly, the system (6) determines an air ventilation phase (10), which allows for creating the necessary depression for vacuuming air from outside, passing it through the different filtration phases and driving the already treated air inside the tower (2). This phase (10) consists of an element (10.1) in the shape of a triangular prism which determines one of its rectangular sides depending on the housing (9.1) of the preceding phase, in other words, the plenum (9), and which has a series of fans (10.2) along one of its sides. The shape of the element (10.1) in this phase (10), as well as the uniformly distributed layout of the fans (10.2), allows for the homogeneous distribution of the air flow through the previous phases, thereby improving filtration efficiency as a whole. Likewise, the prismatic design of this phase allows the opening and closing of the system (6), like a door (3), without banging against the frame.

The fans (10.2), likewise, have a speed regulating system (not shown) which allows for varying the air flow introduced into the tower (2), depending on the flow required for the dissipation of heat generated by the components of the wind turbine.

The regulatory system, according to its preferential execution, is equipped with a speed variator controlled by a regulation control loop which varies the speed of the fans (10.2), depending on the upper temperature limit of the lowest operational mode of critical equipment and/or components detected by a temperature probe (not shown), and on the air flow extracted for ventilation on behalf of the wind turbine's different equipment, detected by a measuring probe, above which the flow of the system fans (10.2) must be maintained in order to maintain overpressure inside the wind turbine.

The regulatory system maintains the required air flow as sedimentation accumulates on the filters (8.2) during the filtration phase (8), by means of a differential pressure probe (not shown) which acts on the upon the fan speed variator's control loop (10.2).

The pressure probe, furthermore, allows for detecting the sedimentation accumulated on the filters (8.2) during the filtration phase (8) by detecting a drop in pressure which determines the need for replacing said filters (8.2).

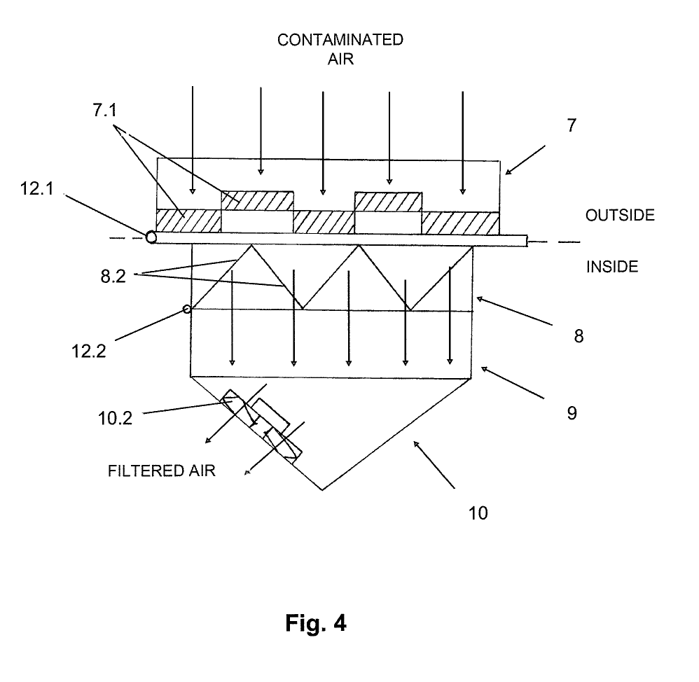

On another hand, (see FIG. 4) the system (6) includes a series of hinges (12.1, 12.2) both for opening the compact unit (6) to access the inside of the tower (2) of the wind turbine (1), as well as for accessing the inside of the components (7, 8, 9 and 10) for maintenance and assembly tasks. The first series of hinges (12.1), those which open like a door (3), are located between the decantation (7) and filtration (8) phases, while those for opening the system (6) for maintenance are repair are located between the filtration (8) and plenum (9) phases. In this way, there is no difficulty in accessing the filters (8.2), which are interchangeable, or accessing the fans (10.2) of the last phase (10).

Given that the treated air circulation system (6) is also the point of access inside the wind turbine (1) for operators responsible for its maintenance, a safety system is required which guarantees that the door or system (6) will not close due to a gust of wind or any other cause which may result in the sudden closure of the door. To this end, the system (6) includes a controlled opening and closing system (13) on its front, mainly made up of an actuator (13.1), which allows for interlocking the system (6) in any opened position, as is shown in FIG. 2.

1. System for circulating treated air inside the wind turbine, of the type which provides air free of dust and sand particles, characterized by having a decantation phase (7) for particles of larger granulometry, a filter phase (8) for particles of smaller size, an air stabilization phase (9) and a treated air ventilation phase (10), which together make up a compact unit to be installed at the access to the inside of the tower (2) of the wind turbine (1).

2. System for circulating treated air inside the wind turbine, according to the first claim, characterized by the fact that the system (6) is installed instead of the access door (3) to the tower (2) of a wind turbine (1).

3. System for circulating treated air inside the wind turbine, according to the first claim, characterized by its decantation phase (7) which is composed of a series of slats (7.1) set up in a staggered formation and a series of holes on its lower part for decanting the sand particles transported by the air from outside.

4. System for circulating treated air inside the wind turbine, according to the third claim, characterized by the fact that the decantation phase (7) has the same shape as the access door (3) to the tower (2) of a wind turbine (1).

5. System for circulating treated air inside the wind turbine, according to the first claim, characterized by its filtration phase (8) which has a sealed rectangular housing (8.1) prepared for accommodating interchangeable filters (8.2) set up in a V-shape for maximum performance of the effective filtration surface.

6. System for circulating treated air inside the wind turbine, according to the first claim, characterized by the fact that the air stabilization phase (9) consists of a plenum with a housing (9.1) whose shape depends on the housing (8.1) of the preceding phase (8).

7. System for circulating treated air inside the wind turbine, according to the first claim, characterized by the fact that the air ventilation phase (10) determines an element (10.1) in the shape of a triangular prism equipped with at least one fan (10.2) and at least one system for regulating the air flow moved by these.

8. System for circulating treated air inside the wind turbine, according to the seventh claim, characterized by the fact that the regulatory system has a speed variator controlled by a regulation control loop which varies the air flow introduced inside the wind turbine (1).

9. System for circulating treated air inside the wind turbine, according to the seventh claim, characterized by the fact that the regulatory system has a differential pressure probe for detecting the sedimentation accumulated on the filters (8.2) and maintaining the target flow as determined by the variator's regulation control loop, and a temperature probe for detecting the upper temperature limit of the lowest operational mode of the wind turbine's equipment (1).

10. System for circulating treated air inside the wind turbine, according to the seventh claim, characterized by the fact that the regulatory system has a probe which measures the flow extracted by the individual ventilation systems of the wind turbine's equipment, in order to establish the minimum, indispensable flow for providing overpressure inside the wind turbine (1).

11. System for circulating treated air inside the wind turbine, according to the first claim, characterized by the fact that there are two sets of hinges, the first set (12.1) for opening and closing the unit like an access door (3) which leads inside the wind turbine (1) and the second set (12.2) for accessing the inside of the system (6).

12. System for circulating treated air inside the wind turbine, according to the first claim, characterized by the fact that the system (6) is installed instead of the access door (3) to the tower (2) of a wind turbine (1).

13. System for circulating treated air inside the wind turbine, according to the eleventh claim, characterized by the fact that the second set of hinges (12.2) is located between the filtration (8) and air stabilization (9) phases.

14. System for circulating treated air inside the wind turbine, according to the first claim, characterized by the controlled system for opening and closing (13) the unit (6) to facilitate its opening, closing and interlocking, as required.

15. System for circulating treated air inside the wind turbine, according to the thirteenth claim, characterized by the fact that the controlled opening and closing system (13) determines an actuator (13.1).

16. System for circulating treated air inside the wind turbine, according to the first claim, characterized by the fact that on at least one wind turbine ventilation grid (1) is installed a gate with mobile slats which closes the air circulation system is functioning.
